(19) United States
(12) Patent Application Publication
(10) Pub. No.: US 2005/0005007 A1
(43) Pub. Date: Jan. 6, 2005

(54) World wide web document distribution system to receiving web display stations with tracking at the receiving station of the extent of usage of documents previously accessed and stored at receiving station

(75) Inventors: Susann Marie Keohane, Austin, TX (US); Gerald Francis McBrearty, Austin, TX (US); Shawn Patrick Mullen, Buda, TX (US); Jessica Kelley Murillo, Hutto, TX (US); Johnny Meng-Han Shieh, Austin, TX (US)

Correspondence Address: International Business Machines Corporation;Intellectual Property Law Department, Internal Zip 4054, 11400 Burnet Road, Austin, TX, 78758, US

(73) Assignee: International Business Machines Corporation, Armonk, NY (US)

(21) Appl. No.: 10/611,021

(22) Filed: Jul. 1, 2003

(51) Int. Cl. G06F 15/173

(52) U.S. Cl. 709/224

(57) ABSTRACT

The tracking of usage of pre-accessed Web documents that are browsed off-line. The combination of apparatus for storing previously accessed network documents, e.g. Web pages, at a receiving display station; and at said receiving display station for tracking data on the extent of usage of these previously accessed documents. The previously accessed and stored Web pages may be hypertext documents that have a plurality of hyperlinks to other previously accessed and stored Web pages, and the tracking of data tracks the number of times that each of said hyperlinks is used to access the stored Web document linked to said hyperlink. In addition, there may be an implementation for transmitting the means for tracking the extent of usage of the previously accessed Web document to said receiving display station along with said previously accessed Web document. The tracking function may, for example, be transmitted to the receiving station in the form of a program routine or applet that accompanies these pre-accessed Web pages.

### TECHNICAL FIELD

The present invention relates to computer managed communication networks, such as the World Wide Web (Web), and particularly to methods of tracking the extent of usage of Web documents accessed by particular, e.g. targeted, users at receiving Web display stations.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web (the two terms are used interchangeably) related distribution of documents, media and programs. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to all matter of documents, media and computer programs.

In addition, Hypertext Markup Language (HTML), which had been the documentation language of the Internet or Web for years, offered direct links between pages and other documentation on the Web and a variety of related data sources, which were, at first, text and then evolved into media, i.e. “hypermedia”. This even further exploded the use of the Internet or Web. The recent rapid expansion of the Web was, to a great extent, based upon giving users access to Web document sources without cost to the receiving user or at least without direct compensation to the document content providers maintaining Web sources. Many of such sources were maintained by government and academic institutions. In such cases, the compensation was the indirect combination of duty and goodwill that traditionally motivated such institutions to maintain libraries.

On the other hand, for the private business sector, the motivation for Web source content providers was a combination of goodwill, advertising and the potential for acquiring customer business. While these motives have compensated many business organizations fairly well, the rapid expansion of Web user bases and the consequent great proliferation of “hits” and demands on Web sources is making the maintenance of free Web sources commercially impractical for a great many business organizations.

Over the years, advertising on the Web display has been used to generate compensation either directly to the content provider or by the collection of advertising revenue from general advertisers by Web service providers that subsequently distribute a portion of such revenue to the Web source content providers. The success of such general advertising on the Web has been quite limited. The interests of a user browsing on the Web are quite specific and personal, while the advertising on the Web has been relatively general, unfocused and broadly directed.

In light of this situation, there have been extensive efforts to direct advertising and related information to the specific interests of Web users. In addition, there has been an increasing market for user services that provide information of interest to the user for business, technological, academic and leisure.

The most effective group of tools for determining general and particular user interest has been the tracing or monitoring of “hits” on Web sites, e.g. the demand for Web pages. In the beginning, such tracking involved the monitoring of hits of particular Web pages from particular Web sites. This gave potential advertisers and Web site hosts general information as to user demand. With the progress in technology, tracking became more sophisticated so that particular user interest could be tracked. This was usually done at the level of the Web service provider for the target user with appropriate compensation for the user for relinquishing privacy. Copending Application Ser. No. 10/159,508, Herman Rodriguez et al., A WORLD WIDE WEB DOCUMENT DISTRIBUTION SYSTEM WITH COMPENSATION FOR DOCUMENT PROVIDERS AND FOR DOCUMENT RECEIVING USERS FOR DISTRIBUTION COSTS BY USERS PERMITTING PROVIDERS TO TRACK THE USERS' DOCUMENT ACCESS ACTIVITIES ON THE WEB, filed on May 30, 2002, and assigned to the assignee of the present Application, provides an example of such specific user monitoring or tracking of Web page usage.

While these specific user tracking implementations have provided effective user tracking of Web document usage, another technological advance has created new problems in specific user tracking of Web document usage.

The rapidly expanding availability of storage capacity, even in mobile palm-type PDA display computers has now made it possible to pre-access Web documents for Web sites and databases and store a relatively extensive quantity of such Web documents on such PDAs and desktop personal computers. This permits the user to browse such Web documents off-line apart from any real-time connection to the Web. The problem of tracking of Web document usage is particularly pronounced because a great amount of this pre-accessing from the Web involves the further pre-accessing of Web documents linked to the basic Web documents through hyperlinks in the basic Web documents. Thus, at most, the existing usage tracking programs would only have a hit or indication of the initial access to the original or linked Web documents but would have no indication of this off-line usage. With the greatly increasing off-line browsing of pre-accessed Web documents, this presents a usage tracking problem worthy of attention.

### SUMMARY OF THE PRESENT INVENTION

The present invention provides one solution to problems related to the tracking of usage of pre-accessed Web documents that are browsed off-line. The invention involves the combination of means for storing previously accessed network documents at a receiving display station; and means at said receiving display station for tracking data on the extent of usage of said previously accessed documents. In the preferred operation, the network is the Web; the documents are pre-accessed from remote resource locations, e.g. Web sites; and the documents are Web documents. The means for tracking data may track the extent of usage of sections of the previously accessed and stored Web documents. The previously accessed and stored Web documents may be hypertext documents that have a plurality of hyperlinks to other previously accessed and stored Web documents, and the means for tracking data tracks the number of times that each of said hyperlinks is used to access the stored Web document linked to said hyperlink. In addition, there may be means for transmitting the means for tracking the extent of usage of the previously accessed Web document to said receiving display station along with said previously accessed Web document. The means for tracking may, for example, be transmitted to the receiving station in the form of a program routine or applet that accompanies these pre-accessed Web pages.

The Web system herein may further include means associated with a network server computer for collecting the tracked data in combination with means for transmitting the tracked data to these means for collecting said data. The receiving display terminal may be a personal palm-type computer connected to the Web through periodic synchronization with an associated receiving display station in turn connected to the Web; and the means for transmitting transmits the tracked data to said means for collecting said data during such periodic synchronization.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of implementing the receiving display station on which the received Web pages may be pre-accessed and stored, and then used; and such usage tracked and stored in accordance with this invention;

FIG. 2 is a generalized diagrammatic view of a Web portion upon which the present invention may be implemented,

FIG. 3 is a general flowchart of a program set up to implement the present invention for storing previously accessed network documents at a receiving display station; and means at said receiving display station for tracking data on the extent of usage of said previously accessed documents; and

FIG. 4 is a flowchart of an illustrative run of the program set up in FIG. 3.

### DETAILED DESCRIPTION OF THE PREFERRED EMBODIMENT

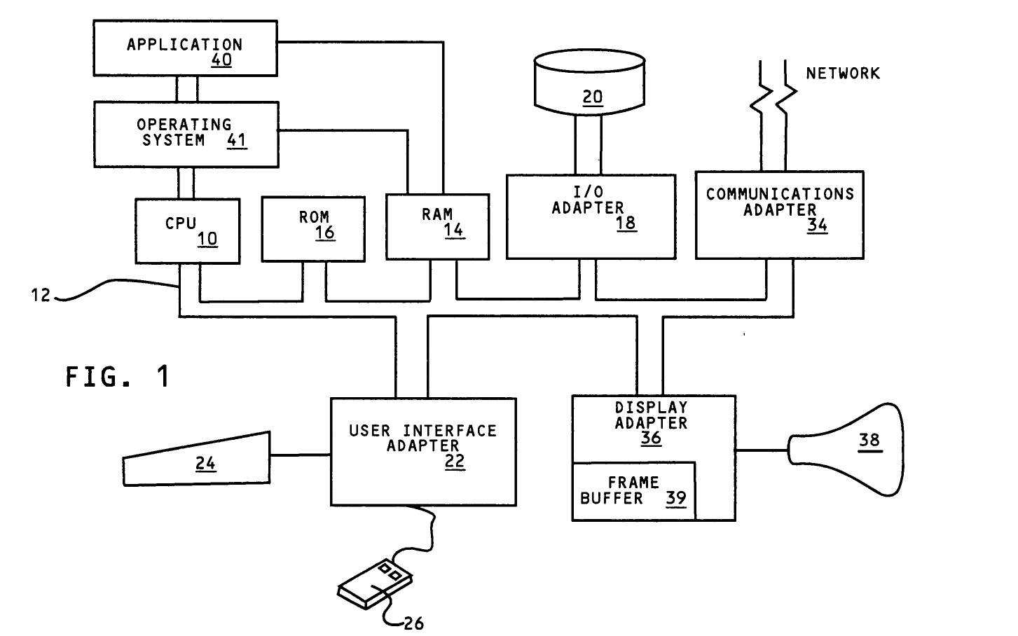

Referring to FIG. 1, a typical data processing terminal is shown that may function as a basic computer controlled Web receiving terminal used in implementing the present invention for storing pre-accessed Web documents in and tracking the extent of usage of such documents off-line from the Web at the receiving display station. The illustrative computer shown may also be used for the Web servers in the practice of the invention. A central processing unit (CPU) 10, such as one of the PC microprocessors or workstations, e.g. RISC IQ System/6000™ series available from International Business Machines Corporation (IBM), or Dell PC microprocessors, is provided and interconnected to various other components by system bus 12. An operating system 41 runs on CPU 10, provides control and is used to coordinate the function of the various components of FIG. 1. Operating system 41 may be one of the commercially available operating systems, such as IBM's AIX 6000™ operating system or Microsoft's WindowsXP™ or Windows2000™, as well as UNIX and other IBM AIX operating systems. Application programs 40, controlled by the system, are moved into and out of the main memory Random Access Memory (RAM) 14. These programs include the program of the present invention that will be described hereinafter in combination with any conventional Web browser at the receiving Web station, such as Netscape 6.0 or Microsoft's Internet Explorer™. The programs will track the usage of the pre-accessed Web documents, including other pre-accessed Web documents that are hyperlinked to the original Web documents. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside Internet or Web network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the programs for tracking the usage of the pre-accessed Web documents including other pre-accessed Web documents that are hyperlinked to the original Web documents. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

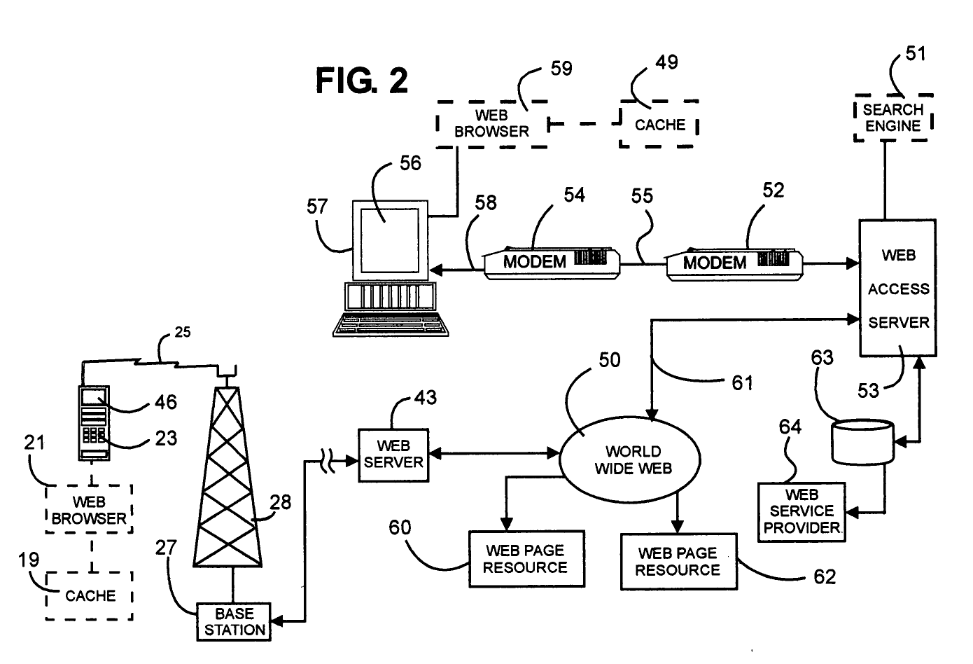

It should be noted that FIG. 1 shows the generalized structure of a desktop receiving Web station, such as station 57, in the Web network portion to be subsequently described with respect to FIG. 2. Where the receiving Web station is a palm-type PDA device hotsynced with a desktop station, as will be described further with respect to FIG. 2, it will have a standard palm-type display computer structure, as described in greater detail in copending application Ser. No. 09/589,666 filed Jun. 8, 2000, B. S. Baweja et al., DISTRIBUTING CONDENSED VERSIONS OF DISPLAYABLE INFORMATION IN HYPERTEXT MARKUP LANGUAGE DOCUMENTS TRANSMITTED ON THE WORLD WIDE WEB TO PERSONAL PALM-TYPE DISPLAY COMPUTERS, assigned to the same assignee as the present invention.

Before going further into the details of specific embodiments, it will be helpful to understand from a more general perspective the various elements and methods that may be related to the present invention. Since a major aspect of the present invention is directed to documents, such as Web pages and media content therein, transmitted over networks, an understanding of networks and their operating principles would be helpful. We will not go into great detail in describing the networks to which the present invention is applicable. Reference has also been made to the applicability of the present invention to a global network, such as the Internet or Web. For details on Internet nodes, objects and links, reference is made to the text, Mastering the Internet, G. R. Cady et al., published by Sybex Inc., Alameda, CA, 1996.

The Internet or Web is a global network of a heterogeneous mix of computer technologies and operating systems. Higher level objects are linked to the lower level objects in the hierarchy through a variety of network server computers. These network servers are the key to network distribution, such as the distribution of Web pages and related documentation. In this connection, the term “documents” is used to describe data transmitted over the Web or other networks and is intended to include Web pages with displayable text, graphics, other images and audio. This displayable information may be still, in motion or animated, e.g. animated GIF images.

Web documents are conventionally implemented in HTML language, which is described in detail in the text entitled Just Java, van der Linden, 1997, SunSoft Press, particularly at Chapter 7, pp. 249-268, dealing with the handling of Web pages, and also in the above-referenced Mastering the Internet, particularly at pp. 637-642, on HTML in the formation of Web pages. The images on the Web pages are implemented in a variety of image or graphic files such % PEG, JPEG or GIF files, which are described in the text, Internet: The Complete Reference, Millenium Edition, Young et al., 1999, Osborne/McGraw-Hill, particularly at pp. 728-730.

In addition, aspects of this invention will involve Web browsers. A general and comprehensive description of browsers may be found in the above-mentioned Mastering the Internet text at pp. 291-313. More detailed browser descriptions may be found in the above-mentioned Internet: The Complete Reference. Millennium Edition text: Chapter 19, pp. 419-454, on the Netscape Navigator; Chapter 20, pp. 455-494, on the Microsoft Internet Explorer; and Chapter 21, pp. 495-512, covering Lynx, Opera and other browsers.

In the description of the invention, search engines will be used to locate and pre-access the previously accessed Web documents stored at the receiving display stations. As described in the above-mentioned Internet: The Complete Reference, Millenium Edition text, pp. 395 and 522-535, search engines use keywords and phrases to query the Web for desired subject matter. In carrying out its search, the search engine looks through the database for matches to keywords subject to the engine syntax. The search engine then presents to the user a list of the Web pages it determines to be closest to the requested query. Some significant search engines are: AltaVista, Infoseek, Lycos, Magellan, Webcrawler and Yahoo.

A generalized diagram of a portion of the Web, in which the computer controlled display terminal 57 used for Web page receiving during searching or browsing is connected as shown in FIG. 2. Computer display terminal 57 may be implemented by the computer system set up in FIG. 1 and connection 58 (FIG. 2) is the network connection shown in FIG. 1. For purposes of the present embodiment, computer 57 serves as the receiving Web display station that will pre-access and store Web documents, e.g. pages that subsequently are displayed 56. Reference may be made to the above-mentioned Mastering the Internet, pp. 136-147, for typical connections between local display stations to the Web via network servers, any of which may be used to implement the system on which this invention is used. The system embodiment of FIG. 2 has a host-dial connection. Such host-dial connections have been in use for over 30 years through network access servers 53 that are linked 61 to the Web 50. The Web servers 53, which also may have the computer structure described with respect to FIG. 1, may be maintained by a Web Service Provider to the client's display terminal 57. The Web server 53 is accessed by the client receiving terminal 57 through a normal dial-up telephone linkage 58 via modem 54, telephone line 55 and modem 52. Any conventional digital or analog linkages, including wireless connections, are also usable. The previously described search engines 51, contacted conventionally via Web access server search the Web, and send the selected Web documents back to the receiving display station 57 on which they may be conventionally displayed on a real-time basis, and documents linked to the hyperlinks in displayed documents selectively accessed by the user from the Web via browser 59 and then displayed 56 on a real-time basis in a conventional manner. Of course, the number of hits and other conventional Web document usage amounts may be tracked in the conventional manner on a real-time basis as described above.

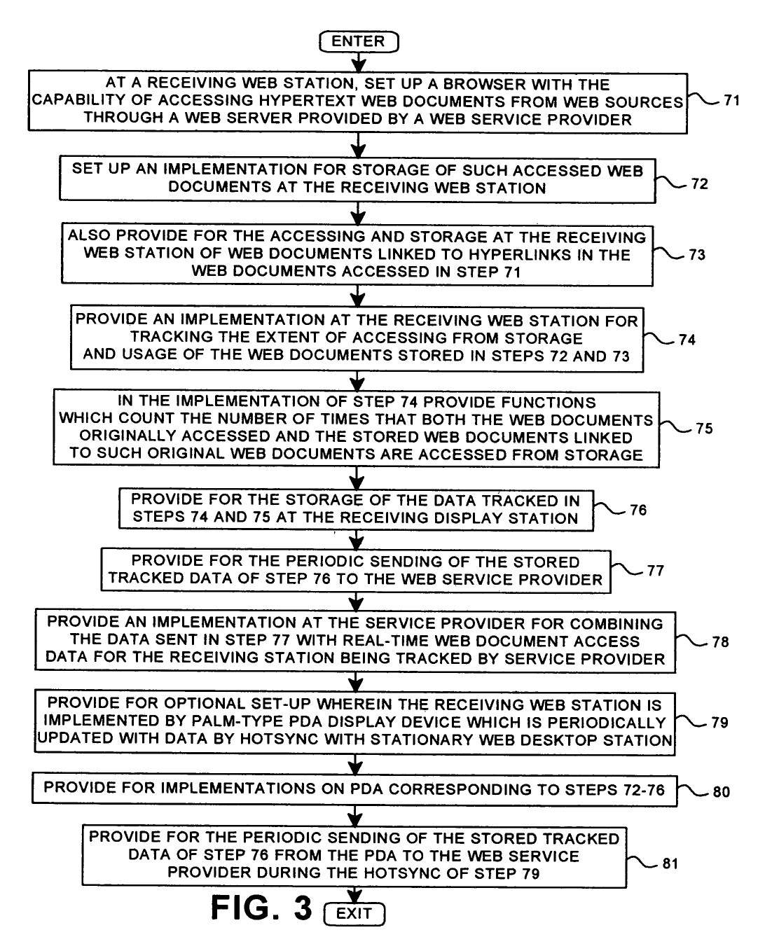

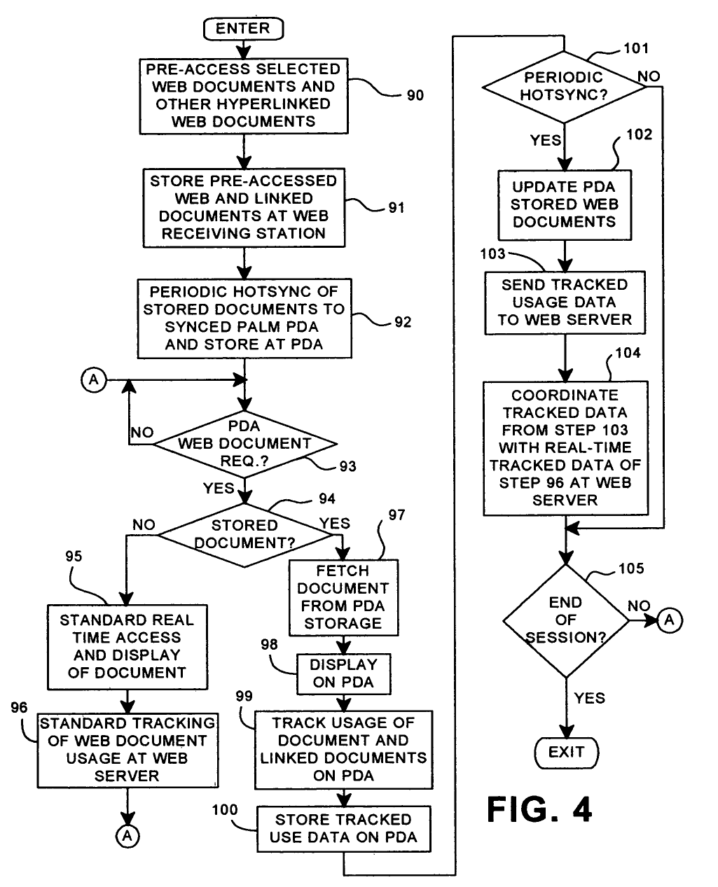

The present invention is concerned with the usage tracking of Web documents and their hyperlinked Web documents that are pre-accessed from the Web as described, but then stored for further accessing and viewing by the user off-line (off the Web) at the user's convenience. These are stored in association with station 57, e.g. in cache 49. As will be described in connection to FIGS. 3 and 4, the invention provides for the tracking of off-line access and usage of Web documents and linked Web documents. Storage capacities at receiving Web stations have increased so substantially that in addition to the basic selected Web documents, all of the hyperlinked Web documents to these basic Web documents may also be stored at the receiving Web station. The present invention provides an implementation for tracking the usage of such previously accessed stored documents. Accordingly, even though such Web pages are stored and read or accessed while the receiving station is off the Web, the tracking routines will count, for example, the number of times that particular hyperlinks on the stored Web page are clicked on so as to access the linked pages that are also stored at the receiving Web station.

The techniques used for the actual tracking of this off-Web access and usage of the stored previously accessed Web documents may be any standard client usage routine already implemented for standard real-time Web document usage tracking. However, the tracking is carried on the stored pre-accessed Web documents. When this tracking is done on a desktop receiving station such as station 57, FIG. 2, the accumulated tracked data is stored at the station, e.g. on cache 49, and then periodically sent to a database 63 maintained by Web provider 64 via Web server 53. Dependent on the usage data algorithm that the service provider is using to develop meaningful usage data, the data relative to the off-line usage of pre-accessed Web documents may be combined with the real-time Web document usage that, of course, may also be accumulated in database 63 by the service provider 64.

In accordance with an aspect of this invention, Web document usage data may also be monitored for palm-type PDAs, such as wireless device 23 with display screen 46. It should be noted that the term personal palm-type device is used to generally cover all varieties of palm-type devices. These include cellular phones and related wireless devices, smartphones and Internet screen phones. In FIG. 2, such a use of a PDA is shown hotsynced to desktop station 57 as described in the above-referenced copending application Ser. No. 09/559,666. PDA 23 is wirelessly connected 25 to a cellular tower 28, in turn connected via a base station of a switching network via Web server 43. It is through this Web connection that the PDA 23 may be synchronized, i.e. hotsynced, to desktop 57 via the desktop Web server 53, as described above. Similar to desktop 57, a storage cache 19 is provided in association with PDA 23 whereby Web documents may be pre-accessed from the Web under the control of Web browser 21 and stored. Then, like the operation at the desktop station 57, the basic selected Web documents and all of the hyperlinked Web documents to these basic Web documents may also be stored at the receiving PDA station. The present invention provides an implementation for tracking the usage of such previously 21 accessed stored documents. Accordingly, even though such Web pages are stored and read or accessed while the receiving station is off the Web, the tracking routines will count the number of times that particular hyperlinks on the stored Web page are clicked on so as to access the linked pages that are also stored at the receiving PDA. The tracked data will be stored on cache 19 and similarly provided via the Web to database 63 under the control of Web service provider 64. The accumulated usage data may conveniently be periodically transmitted from cache 19 to database 63 during the above-mentioned hotsync operations.

FIG. 3 is a flowchart showing the development of a process according to the present invention for tracking Web documents previously accessed from the Web and stored at a receiving Web station for usage by the clients at such Web stations. Most of the programming functions in the process of FIG. 3 have already been described in general with respect to FIGS. 1 and 2. A Web browser is provided at a receiving display station on the Web for accessing Web pages in the conventional manner and loading them at the display station, step 71. The Web pages are conventionally obtained via a Web server provided by a Web Service Provider. The Web browser has the capability of requesting searches from one or more search engines available through the Web. An implementation is set up for the storage of such accessed Web pages at the receiving Web station, step 72. There is also provision at the Web station for pre-accessing, step 73, the Web pages connected to the hyperlinks in the Web pages pre-accessed in step 71. An implementation is provided at the Web station, step 74, for the tracking of the extent of fetching from the storage and the extent of usage of the Web pages accessed in steps 72 and 73. In the implementation of step 74, there may be provided a variety of functions for tracking, e.g. functions that count the number of times that both the original Web pages and the linked Web pages are accessed from storage, step 75. Provision is made, step 76, for the storage of the data tracked in steps 74 and 75 at the receiving display station. Provision is made for the periodic sending of the tracked stored data of step 76 to the Web service provider, step 77. There is an implementation at the service provider for combining the data sent in step 77 with real-time Web page access data for the receiving station being tracked by the service provider, step 78. There is provision for an optional set up in which the receiving Web station is implemented by a palm-type PDA device that is periodically updated with data by a standard hotsync with a stationary Web desktop computer station, step 79. Provision is made, step 80, for the implementation of corresponding steps 72 through 76 on the PDA. Provision is made, step 81, for the periodic sending of the stored tracked data of step 76 of the PDA to the Web service provider during the hotsync of step 79.

The running of the process set up in FIG. 3 will now be described with respect to the flowchart of FIG. 4. First, step 90, Web pages selected for the user, as well as the Web pages linked to the hyperlinks in the Web pages, are pre-accessed via a Web browser at a receiving display station. Such pre-accessed Web pages are stored at the receiving station, step 91. Since this example is a PDA implemented one, step 92, there will be a periodic hotsync of the stored Web pages to the PDA. Then, a determination is made, step 93, as to whether there has been a Web page request made by the user. If No, such a request is awaited. If Yes, then, step 94, a further determination is made as to whether the requested page has been pre-accessed and, thus, stored. If No, then the process follows a standard real-time Web page request routine, step 95, in which the requested Web page is accessed from the Web and displayed and subjected to any standard tracking of the Web page usage, usually conducted at the Web provider server, step 96. When the user is finished with the Web page, the process is returned to step 93 via branch “A”. If the determination instep 94 is Yes, the requested Web page has been pre-accessed and stored, then, step 97, the page is fetched from PDA storage and displayed on the PDA, step 98. Page usage is tracked as described hereinabove, step 99, and the data is stored in association with the PDA, step 100. Next, periodic determinations are made, step 101, as to whether there is a hotsync. If Yes, the PDA is sent the standard update including the new pre-accessed Web pages, step 102. In turn, the PDA sends whatever tracked usage data it has stored to the Web service provider server, step 103. Provision may be made, step 104, at the service provider, as described above, for the coordination of the tracked data sent instep 103 with any real-time Web page usage data tracked in step 96. At this point, or if the determination from step 101 is No, a determination may conveniently be made as to whether the Web session is at an end. If Yes, the session is exited. If No, the process is returned to step 93 via branch “A”.

Although certain preferred embodiments have been shown and described, it will be understood that many changes and modifications may be made therein without departing from the scope and intent of the appended claims.

1. In a computer managed communication network with user access via a plurality of receiving computer display stations connected through network server computers to network documents transmitted to said receiving stations from remote resource locations on said network, a system for tracking the usage of previously accessed and stored network documents comprising:
means for storing a previously accessed network document at a receiving display station; and
means at said receiving display station for tracking data on the extent of usage of said previously accessed document.

2. The network system of claim 1 wherein:
said network is the World Wide Web;
said remote resource locations are Web sites; and
said documents are Web documents.

3. The World Wide Web system of claim 2 wherein said means for tracking data track the extent of usage of sections of said previously accessed and stored Web document.

4. The World Wide Web system of claim 2 wherein:
said previously accessed and stored Web document is a hypertext document having a plurality of hyperlinks to other previously accessed and stored Web documents; and
said means for tracking data tracks the number of times that each of said hyperlinks is used to access the stored Web document linked to said hyperlink.

5. The World Wide Web system of claim 2 further including means for transmitting said means for tracking said extent of usage of said previously accessed Web document to said receiving display station along with said previously accessed Web document.

6. The World Wide Web system of claim 4 further including:
means associated with a network server computer for collecting said tracked data; and
means for transmitting said tracked data to said means for collecting said data.

7. The World Wide Web system of claim 6 wherein said receiving display terminal is a mobile personal palm-type display computer.

8. The World Wide Web system of claim 7 wherein:
said personal palm-type computer is connected to the World Wide Web through periodic synchronization with an associated receiving display station connected to the Web; and
said means for transmitting transmits said tracked data to said means for collecting said data during such periodic synchronization.

9. In a computer managed communication network with user access via a plurality of receiving computer display stations connected through network server computers to network documents transmitted to said receiving stations from remote resource locations on said network, a method for tracking the usage of previously accessed and stored network documents comprising:
storing a previously accessed network document at a receiving display station; and
tracking, at said receiving display station, data on the extent of usage of said previously accessed document.

10. The method of claim 9 wherein:
said network is the World Wide Web;
said remote resource locations are Web sites; and
said documents are Web documents.

11. The World Wide Web method of claim 10 wherein the extent of usage of sections of said previously accessed and stored Web document is tracked.

12. The World Wide Web method of claim 10 wherein:
said previously accessed and stored Web document is a hypertext document having a plurality of hyperlinks to other previously accessed and stored Web documents; and
the number of times that each of said hyperlinks is used to access the stored Web document linked to said hyperlink is tracked.

13. The World Wide Web method of claim 10 further including the step of transmitting a program for tracking said extent of usage of said previously accessed Web document to said receiving display station along with said previously accessed Web document.

14. The World Wide Web method of claim 12 further including the steps of:
collecting said tracked data in association with a network server computer; and
transmitting said tracked data from said receiving display station for said collection.

15. The World Wide Web method of claim 14 wherein said receiving display station is a personal palm-type computer and including the steps of:
connecting said personal palm-type computer to the World Wide Web through periodic synchronization with an associated receiving display station connected to the Web; and
transmitting said tracked data for collection during such periodic synchronization.

16. A computer program having code recorded on a computer readable medium for tracking the usage of previously accessed and stored Web documents in a World Wide Web network with user access via a plurality of receiving display stations connected through Web server computers to Web documents transmitted to said receiving stations from remote Web sites on said network, said computer program comprising:
means for storing a previously accessed Web document at a receiving display station; and
means at said receiving display station for tracking data on the extent of usage of said previously accessed Web document.

17. The computer program of claim 16 wherein said means for tracking data track the extent of usage of sections of said previously accessed and stored Web document.

18. The computer program of claim 16 wherein:
said previously accessed and stored Web document is a hypertext document having a plurality of hyperlinks to other previously accessed and stored Web documents; and
said means for tracking data tracks the number of times that each of said hyperlinks is used to access the stored Web document linked to said hyperlink.

19. The computer program of claim 16 further including means for transmitting said means for tracking said extent of usage of said previously accessed Web document to said receiving display station along with said previously accessed Web document.

20. The computer program of claim 19 further including:
means associated with a Web server computer for collecting said tracked data; and
means for transmitting said tracked data to said means for collecting said data.

21. The computer program of claim 20 wherein:
said receiving display terminal is a mobile personal palm-type display computer connected to the World Wide Web through periodic synchronization with an associated receiving display station connected to the Web; and
said means for transmitting transmits said tracked data to said means for collecting said data during such periodic synchronization.
